(19) United States
(12) Patent Application Publication
(10) Pub. No.: US 2014/0020089 A1
(43) Pub. Date: Jan. 16, 2014

(54) Access Control System using Stimulus Evoked Cognitive Response

(71) Applicant: Remo Peter Perini, II, Vienna, VA (US)

(72) Inventor: Remo Peter Perini, II, Vienna, VA (US)

(21) Appl. No.: 13/940,775

(22) Filed: Jul. 12, 2013

Related U.S. Application Data
(60) Provisional application No. 61/671,396, filed on Jul. 13, 2012.

(51) Int. Cl. G06F 21/32

(52) U.S. Cl. CPC G06F 21/32
USPC 726/19

(57) ABSTRACT

The ACSSECR invention is a biometric access control system and methodology that measures cognitive, psychophysiological responses to stimuli to confirm the identity of an individual. As an alternative to “Logging in” with a user ID and password, this cognitive biometric authentication system is used for “Cogging in” to a system with user ID and user-selected “Cogkey”. ACSSECR is designed for strict access control scenarios where significant authentication confidence is required to gain access to controlled information, facilities, systems, vehicles, or devices. The system takes advantage of a behavioral and physiological characteristic of humans that is an unconscious response to a stimulus. The Event Related Potential (ERP) response (specifically the P3 ERP) involuntarily occurs when an individual perceives and reacts to an unexpected, task-relevant event. The task is for the user to recognize their Cogkey which is presented infrequently amidst more frequent non-target stimuli. There is no requirement for extensive enrollment by users, only the recognition of their Cogkey. The basic system does not store biometric data for comparison, but rather measures the user's Cogkey recognition responses in comparison to non-Cogkey stimulus responses. An individual can have multiple personas with different Cog keys.

### CROSS REFERENCE TO RELATED APPLICATIONS

Provisional patent application Ser. No. 61/671,396 dated 13 Jul. 2012 is used to establish priority

### FIELD OF THE INVENTION

The ACSSECR invention is an access control system and method for capturing, measuring and analyzing biometric information using electroencephalogram (EEG) to confirm the identity of an individual, specifically to authenticate the individual based on their cognitive response to specific stimuli related to a shared secret.

### BACKGROUND OF THE INVENTION

“Biometrics” is the science and technology of authenticating human beings using biological data. Current biometric modalities, fingerprint, retinal scan, face recognition, etc., have limitations, operational restrictions and can be exploited. The ACSSECR system provides a ne biometric modality that overcomes some of these limitations and makes use of psychophysiological event-related potentials (ERPs). Psychophysiology is the study of physiological, cognitive, and behavioral processes in the body. ERPs, sometimes called “brainwaves” in the vernacular, are responses to stimuli, and include cognitive ERPs, which are triggered by cognitive processes. The brain involuntarily generates low-frequency signals that can be measured or monitored through an electroencephalogram (EEG). ERPs are triggered by visual, auditory, or tactile stimuli and, through signal analysis, can be extracted from the normal EEG noise threshold, providing measurable data in the microvolt (uV) range. Using appropriate stimuli, the resulting EEG data can be processed and analyzed to accurate individually authenticate individuals for access control.

The neurophysiological mechanism underlying this cognitive process is associated with synaptic potentials in cortical pyramidal cells. These elongated cells transfer neural current through their interior from one membrane interface to the next, where electrochemical ionization creates ohmic diffusion and transmembrane current flow. A measurable extracellular potential results from the movement of positive and negative ions through biological tissue. That measurable potential can be collected by sensors and monitored via EEG. The electro-cortical activity begins with the subject perceiving or categorizing a stimulus; thus the response is described as psychophysiological. Psychophysiology is the study of the relationship between physiological processes and thoughts, emotions, and behavior; between mental (psyche) and physical (physiological) processes.

Several brainwave signals (ERPs) respond to external stimuli, producing positive or negative voltage peaks. Some of these signals are shown in FIG. 2, including the P1 (P100) (1) and N1 (N100) (2) signals that occur approximately 100 msec post stimulus as a subject perceives or detects the stimulus, and the P3 (P300) signal (3) which occurs when the subject recognizes something already seen, heard or known that is unexpected. The ACSSECR methodology uses the P3 ERP, a positive radio frequency (RF) voltage in the 9 Hz to 60 Hz range, generated by cognitive processes, that appears between 250 and 600 msec after a target stimulus. It is also the third prominent component following stimulus presentation (hence the name P3). The P3 is a cognitive ERP involved with thought or perception. The P3 ERP is related to user's evaluation or categorization of the stimulus. As such it is an “endogenous” (cognitively generated) potential. The P3 ERP is used as a combined physiological and behavioral authentication factor with characteristics new to the field of biometrics. ACSSECR uses this neurophysiological mechanism in the IT application of authenticating identities of persons requesting right to use to an access controlled information system, facility, space, or device.

### DISCUSSION OF PRIOR ART

Before submission of the provisional patent related to this work, a patent search was performed by the National Patent Service (Search number NPS 11130). There are numerous papers with titles suggesting EEG and cognitive biometrics. These papers propose techniques that involve user enrollment (often over several sessions and days), and complex EEG feature extraction using autoregression coefficients, machine learning, discriminant analysis, neural networks, etc. Many of these papers propose multimodal collection including ECG, EMG, Mri, EDR (dermal) and HEG (brain blood flow analysis). These approaches are not relevant to this invention.

The majority of the prior art attempts to collect cognitive responses to stimuli through measurement of an overall brain pattern and then matching that pattern to a subsequent measurement conducted at a later time. This “bulk brain pattern matching” described by these papers or patents is used to authenticate the person's identity. Extensive research has demonstrated that cognitive responses change due to stress, age, distraction, and even familiarity with the stimulus, making the comparison of “bulk responses of the brain” impractical at best. Temporal comparison of a person's overall brain pattern will not result in an exact match, making the provision of a precise confidence level (e.g., 99% confidence) infeasible. Many existing patents describing EEG or cognitive biometrics have been reviewed. Any of these that are even partially relevant are discussed below. The following works are related to use of EEG as a biometric for authenticating individuals:

Patent number US2009/0156956, published Jun. 18, 2009, “Method of determining whether a test subject is a specific individual” is EEG based, uses an EEG cap, and uses amplitude of the P300 signal. (This patent is related to Patents U.S. Pat. No. 7,594,122 and US6977, the former published Sep. 22, 2009) One who is skilled in the art will recognize that the methodology is entirely different than this invention. It requires an enrollment that records EEG over a first period of time using sensory stimuli, then uses at least one of the same stimuli in a second period to compare P300 amplitudes. If the P300 is the same or lower amplitude, it is not the same person. The inventor did not explain how the P300 amplitude degradation that naturally occurs with individual age and with stimulus familiarity is accommodated. The system also uses electrode gel which is highly intrusive. This patent is not relevant to the claims of the ACSSECR invention.

Patents US2009/0156956 and US2010/ 0069775, the latter published Mar. 18, 2010, “EEG related methods” is EEG based, uses an EEG cap, view screen, an eye blink switch, and reference on the mastoid(s). This method measures attitude and individual alertness by evaluating alpha waveband power component ratios and the theta band power component ratio. It requires comparison of P300 amplitudes from two separate collection periods. The method described by patents US2009/0156956 and US2010/0069775 are not relevant to the ACSSECR invention.

Patent U.S. Pat. No. 7,249,263, Published Jul. 24, 2007, “Method and system for user authentication and identification using behavioral and emotional association consistency” (related to patent US2005/0022034), uses emotional and/or psychological profile of user based on EEG. The method requires enrollment, and no analysis method is included in the patent specification. The method described by patent U.S. Pat. No. 7,249,263 is not relevant to the ACSSECR invention.

Patent number U.S. Pat. No. 8,065,529, published Nov. 22, 2011, “Method for using biometric parameters in the ID of persons”, uses EEG, but EEG uses processed phase-space distribution functions to compare digital signature data to enrollment data. The use of a complex enrollment and the EEG signature makes patent U.S. Pat. No. 8,065,529 of little relevance to the ACSSECR invention.

Patent number US 2009/0063866, Published May 5, 2009, “User authentication of evoked potential in EEG signals”, is a user authenticating method that involves obtaining EEG response from user in accordance with perceptory stimuli. The method may use P300. The method may involve initial enrollment of recording EEG responses to stimuli. The stimuli follow a rule and/or violate a rule (shared secret) using shapes. While similar in use of a shared secret, this method requires user training and enrollment and is not relevant to the ACSSECR invention.

Patent number US 2005/0022034, Published Jan. 27, 2005, “Method and system for user authentication and identification using behavioral and emotional association consistency”, Generates a behavioral profile by presenting person with stimulus during enrollment. The method requires application of stimulus to user in enrollment stage and generating model representing user's response to the stimulus. Subsequent post-enrollment evaluation compares behavioral response. Method does not describe how analysis would be performed. The method described by patent number US 2005/0022034 is not relevant to the ACSSECR invention.

Patent number U.S. Pat. No. 5,325,862, Published Jul. 5, 1994, “Method and/or system for person identification and impairment assessment from brain activity patterns”, uses ERPs and EEG sensors. The method requires that brain activity patterns are stored in database and uses a neural network for later comparison. The method described by patent number U.S. Pat. No. 5,325,862 is not relevant to the ACSSECR invention.

U.S. Pat. No. 8,135,957, published Mar. 13, 2012, “Access control system based on brain patterns”, is a control system for access control of an application system using biometric reaction comprising a brain pattern of a user. The biometric reaction triggered by stimulatory information presented to the user. The method uses EEG, EOG and EMG. No analysis methodology described and the patent is not relevant to the ACSSECR invention.

It is important to note that one cannot simply measure and store user P3 ERP responses to stimuli and compare the amplitude of those responses at a later time for the purpose of authentication. As an individual becomes familiar with P3 ERP testing, habituation reduces the surprise and decreases the P3 ERP peak amplitude. Several instances of the prior art do not take this into consideration. The ACSSECR invention does no store P3 ERP responses for subsequent comparison.

### SUMMARY OF INVENTION

The ACSSECR invention provides a system and methodology to provide authentication of individuals based on real time analysis of EEG data. The system generates Authentication Confidence Levels (CLs) in response to a user request for access to a controlled information repository, facility, system, vehicle or device. Using the cognitive response to pre-selected stimuli, the invention replaces the method of “logging in” with a new approach called “cogging in” to an access controlled system, with authentication confidence levels achievable from 99% to 99.99%. The method exploits a behavioral and physiological characteristic of humans that is an involuntary response to a stimulus. This unconscious response results in an electrical potential difference in the brain, triggered by the cognitive function of associating a stimulus with memories of the same or similar category stimulus. The ERP primarily used by this method is the P3 ERP, which is elicited through the presentation of stimuli. The ERP is collected using non-contact or dry, low-intrusion sensors in proximity to the scalp, and wirelessly transmitted to the EEG processing system.

Unlike other patents cognitive biometric or authentication patents, this invention does not try to measure ad store bulk brain response data for later comparison, a capability that may be impossible due to the ever-changing aspects of the human brain. Rather, the invention uses EEG processing and analysis algorithms to compare responses to target and non-target stimuli. The stimuli can be visual, auditory or tactile or a combination of these (computer generation of tactile stimuli is a new technology that is not discussed any further). The pre-selected target stimulus are called cogkeys (Cognitive Keys similar to passwords) can be imbedded in a larger stimulus, such as an image embedded in a larger image, or a particular sound embedded in a background of other sounds. Infrequent cogkeys (known by the user) and random more prevalent non-target stimuli are rapidly presented to the user.

The method applies a complex data collection and processing algorithm to convert raw EEG data into an averaged peak response for both target and non-target stimuli. The P3 ERPs elicited by the target stimuli are easily discriminated from the peak voltages in the same detection window following the non-target stimuli. The method uses a statistical processing algorithm that compares target and non-target responses, providing a biometric identification authentication confidence level (e.g., 99.99%, 99.9% . . . 90%, 80%, etc.) from which the user is either allowed or denied access to the information system, facility, device, etc. The ACSSECR approach is highly flexible, providing a system administrator with a variety of options to meet organizational security requirements.

Although accuracy is imperative, reducing the intrusion factor of a biometric test is nearly as important as the test's accuracy. When logging into an information system, a biometric verification should use very limited time with minimal subject engagement. Similarly, for gaining access to facilities, SCIF space, controlled information or devices, users do not expect a lengthy evaluation of their credentials. The ACSSECR invention uses a variety of techniques to reduce the elements of intrusion and time required to provide accurate authentication. The methodology is simple, does not require user training or user enrollment, does not require storage of biometric data, and can be adapted to any information system, facility or device, including smart phones and tablets. ACSSECR can be used as an alternative to conventional passwords, or as an additional identity confirmation factor.

### BRIEF DESCRIPTION OF DRAWINGS

FIG. 1 is the end-to-end physical system showing the presentation of stimuli by the Stimulus Presentation Unit (SPU), raw EEG data collection by the Wireless EEG Collection Unit (WECU), EEG processing by the EEG Collection and Processing Unit (ECPU), separation and processing of P3 ERPs in the CPU, statistical analysis by the Statistical Processing Algorithm (SPA), Authentication confirmation by the Authentication Control Unit (ACU), and finally, Access Control.

FIG. 2 shows several Event Related Potentials (ERPs) after initial EEG processing, including a P100, N100 and P300.

FIG. 3 depicts the functional flow for how the system obtains stimuli and creates the target and non-target stimulus files.

FIG. 4 shows the stimulus presentation functional flow.

FIG. 5 depicts raw EEG data from 8 sensors over a two second period.

FIG. 6 shows an example of an 8 sensor EEG configurations.

FIG. 7 shows an example of an 22 sensor EEG configurations.

FIG. 8 shows an example of low-intrusion wireless EEG collection apparatus with eight integrated no-contact amplified sensors, transmitter and optional speakers for auditory input.

FIG. 9 an example of low-intrusion wireless EEG collection apparatus with 22 integrated no-contact amplified sensors, transmitter and optional speakers for auditory input.

FIG. 10 is the first of several flowcharts showing target and non-target EEG processing.

FIG. 11 shows target averaged responses and the peaks within the measurement windows.

FIG. 12 shows non-target averaged responses and the peaks within the measurement windows.

FIG. 13 is the second EEG processing flow diagram

FIG. 14 depicts the statistical processing functions

FIG. 15 depicts Non-Overlapping Target and Non-Target Confidence Intervals (CIs)

FIG. 16 shows the flow of the final analysis and allow/deny access decision.

FIG. 17 depicts the table of target and non-target amplitude and latency measurements used by the statistical processing function.

FIG. 18 is the Student's t distribution look-up table used by the statistical processing function.

FIG. 19 is an example of the calculation results of a high Confidence Level Authentication (99.9% confidence)

FIG. 20 depicts the calculation results of a low Confidence Level Authentication (marginal 90% confidence)

FIG. 21 depicts the analysis window narrowing method for a target response that enables very rapid presentation of stimuli with mitigation of cognitive response overlap.

FIG. 22 depicts the analysis window narrowing method for a non-target response outside of the narrowed window

### DETAILED DESCRIPTION OF THE INVENTION

Unlike most authentication and identification systems, the current invention does not require a lengthy biometric enrollment stage. The preferred embodiment of the system does not store a complex EEG model of each user, nor does it use autoregression, discriminant analysis, a neural network or machine learning, like much of the prior art. Rather, the system uses a shared secret, similar to a user password, that, when recognized by the user, will generate a measurable cognitive response called an Evoked Response Potential (ERP).

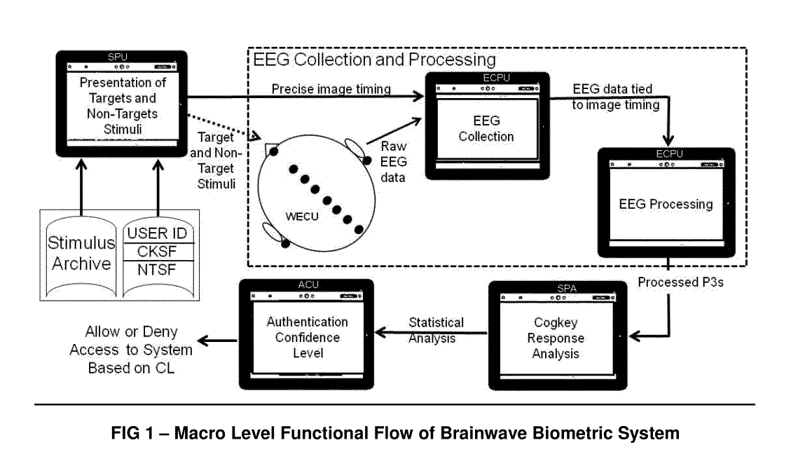

FIG. 1 shows the high level view of the system which includes a stimulus archive, Cogkey Stimulus File (CKSF), Non-target stimulus file (NTSF), stimulus presentation unit (SPU), wireless EEG collection unit (WECU), EEG collection and processing unit (ECPU), a statistical processing algorithm (SPA) and an access control unit (ACU).

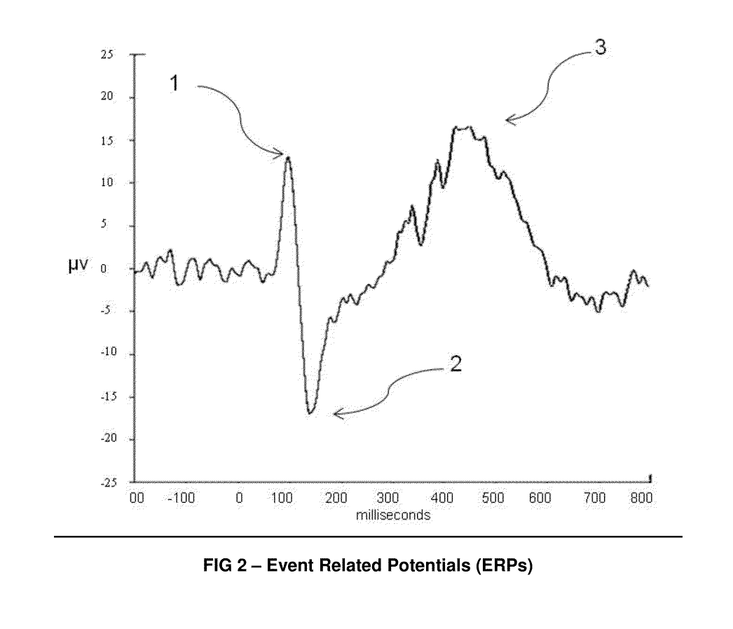

The preferred embodiment uses the most prominent ERP, the P3 shown in FIG. 2, to measure the cognitive response to target and non-target stimuli. Significant difference in response to these two stimuli types creates an authentication confidence level used to allow or deny access to the device, system, facility, etc.

### Psychophysiology Background and the P3 ERP

The current invention employs a behavioral and physiological characteristic of humans that is an obligatory response to a stimulus. The response involuntarily occurs when an individual perceives and reacts to an unexpected, task-relevant event. The unconscious response results in a measurable electrical potential difference in the brain, triggered by the cognitive function of associating the observed stimulus with stored memories of the same or similar category stimulus. The current invention associates a user shared secret, known only to the user and the information system, with target stimuli. The ERP “event” is the user detection of the target and the ERP “potential” is the measured P3 response. The shared secret or target stimulus is called the Cogkey.

The invention elicits P3 ERPs from subjects by presenting audio or visual stimuli with a small percentage of the stimuli (in the preferred embodiment, 10-20%) associated with the users Cogkey. Examples of Cogkeys include images, such as a blue car, a palm tree or a specific person. A user's Cogkey may include a dozen different images of different blue cars, each imbedded in a more complex image, or the words, “blue car”, or a drawing of a blue car. The user's Cogkey could be a specific model of blue car or only blue cars with headlights on. All would elicit the P3 ERP when the user recognizes the image. Images of human faces are very easily recognized and make good Cogkeys (e.g., Albert Einstein, Abraham Lincoln, images of any US President, a childhood friend, etc.) as do human voices. Examples of different audio Cogkeys are the first few notes of Beethoven's 5^{th} Symphony, a specific person saying “hello”, or a common environmental sound. The invention allows a user to select the word “hello” stated by one specific person as their Cogkey or the word “hello” spoken by anybody. The invention does not require that the user select the Cogkey, it could be selected by the system administrator to conform to organizational security requirements, but a more robust P3 ERP response will be elicited if the user sees or hears the Cogkey (or Cogkeys) prior to initially “Cogging in” for the first time. Alternately, the user can be told that their Cogkey is “shark”, or “clock” the color orange, the sound of a bell, etc., and they will elicit a P3 ERP when that target image is presented. Simple Cogkeys such as these may be used as the system-provided initial Cogkeys “that must be changed” after Cogging in for the first time. The invention allows for varying degrees of Cogkey complexity, from single images or sounds as a Cogkey, to several related images or sounds (e.g., a dozen different palm trees) that may be imbedded in more complex images or sounds (e.g., palm trees at a beach, in a garden, in a painting, on a label, etc.).

A user can have more than one “persona” on a system each with its own Cogkey. For example, the system administrator of the system may have one Cogkey for administrative access and another Cogkey for standard user access. Each Cogkey provides access to specific functions related to that user or persona.

Auditory stimuli evoke other sustained potentials that may not be seen in visual ERPs adding a degree of complexity to extraction of the P3 ERP. Additionally, while a image stimulus can be presented very rapidly with stimulus durations of 100 msec and ISIs of 250 msec or less, audio stimuli are typically longer in duration (up to a second) potentially increasing the authentication session.

The invention precludes “shoulder surfing”, a form of theft that involves standing behind a user that is logging in (or Cogging in) to a system and trying to steal the person's access control shared secret (e.g., password, PINs, security code). Stealing an individual's Cogkey (for Cogkey images) is mitigated through selection and presentation of random non-targets based on the user's selected Cogkey. For example, non-target images surrounding the Cogkey “blue car” could include hundreds of random images, some of which may be cars or trucks of another color. The visual Cogkey is hidden by surrounding it with similar images so the Cogkey cannot be discerned.

Since the magnitude of the P3 ERP varies inversely with the frequency of occurrence of the eliciting event, the invention is designed to generate significantly more non-targets stimuli than Cogkey (target) stimuli (no more than 10-20% target stimuli).

### Method Summary

The ACSSECR invention uses a unique method for eliciting the P3 ERP brainwave from the cognitive activity of categorizing target versus non-target stimuli. The target is the anticipated Cogkey, and the non-targets are the large majority of stimuli (sounds or images) presented. The system measures P3 ERP signals using EEG to corroborate the identity of the subject. The invention averages P3 ERP brainwave signals over a short period while the subject either observes images flashed on a display or listens to audio presented through headset speakers. These stimuli elicit a cognitive response used by this invention as a cognitive psychophysiological biometric modality for differentiating between users requesting access to information, devices, facilities or systems and authenticate them for access to those systems.

The invention calculates the amplitude of a subject's averaged ERP response to the Cogkey(s) and statistically compares it to responses to non-target stimuli. The invention converts the target and non-target statistical comparison into a confidence level (CL) that shows the degree to which the user cognitively recognizes his or her chosen Cogkey. As more stimuli are presented, the CL improves for authorized users and either deteriorates or remains constant for an illegitimate user trying to illegally gain access. The method uses statistics to calculate the target and non-target confidence intervals that assure responses are differentiated with no overlap of those intervals. The method is repeatable and provides consistent results.

The method is broken into four distinct parts: 1) Acquiring, Generating and Presenting the Stimulus, 2) EEG Data Collection, 3) EEG data Processing, and 4) Statistical Analysis and Biometric Confirmation of Identity. The invention also includes a minimum intrusion EEG sensor apparatus.

### Acquiring, Generating and Presenting the Stimulus

The method includes user selection of their Cogkey as their “shared secret” or target. In operations, this Cogkey would only be known to the subject and the access control system to confirm that subject's identity to gain access to that system. Upon Cogging in for the first time, the user types in a user ID (e.g., first initial, middle initial, first four letters of last name) that the user will always use to identify who they are to the access control system. Depending on the information system policy, the system may provide the user with an initial Cogkey that may be changed, or a system-determined permanent Cogkey, or the user may select a permanent Cogkey. If the latter, the ACSSECR system will ask the user a series of questions to create the stimulus file or provide a menu-driven drill-down of stimulus categories to select from. This is not “enrollment” in the typical sense as the system is not collecting biometric data for later comparison, but rather a user profile for subsequent generation of stimuli.

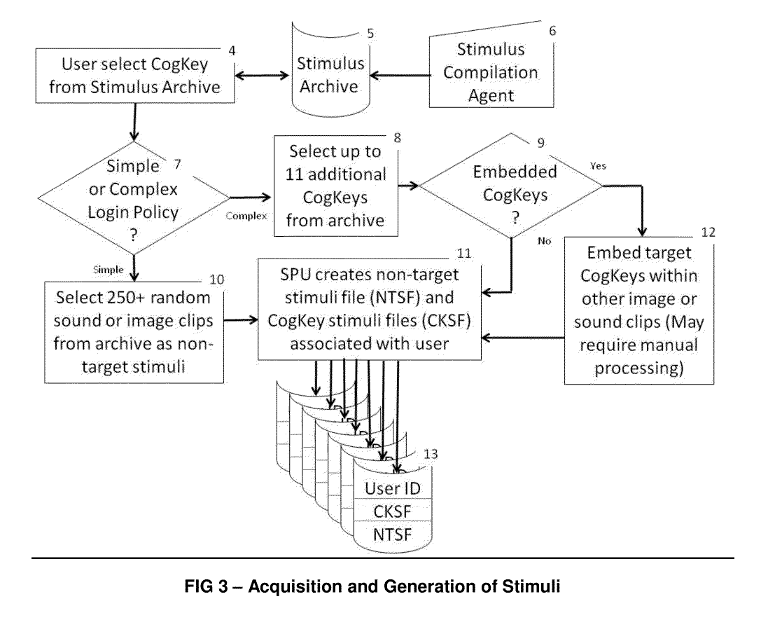

FIG. 3 shows the process for acquiring and generating the stimuli. The stimulus archive (5) is managed by the system administrator who runs an internet search agent utility (6) to locate and compile an audio and visual stimulus archive. Both the search utility and collected stimuli are freeware or open source. The system administrator is responsible for tagging the stimuli (if they are not tagged already) to categorize the stimuli for efficient sorting, search and retrieval.

From the Stimulus Archive, the user may select audio, visual or combined Cogkeys (based on system security policy). The invention allows that a user (or administrator) may select a type of image or sound (4). Examples of target images include: landscape, face, object, art, color, words, numbers, abstract, etc. The corresponding non-target images can be any combination of these. Examples of sounds include, spoken words, human voice other than words, music, noises, animal sounds, computer generated sounds, etc. The corresponding non-target sounds can be any combination of these. The invention contains an extensive database archive of images and sounds. The stimulus archive is continually updated by the stimulus compilation agent that searches the internet for freeware images and sounds to add to the database. There are hundreds of websites that offer free images and sound clips and billions of images and sound clips available. System administrators and users can add stimuli to the database that meet system security requirements. All stimuli are tagged with metadata to facilitate archival segregation of collected stimuli into separate datasets for spoken words, sounds, noises, music clips, object images, art images, color images, written words, etc.

The invention allows for an information system access control policy to permit either a single or multiple (up to a dozen) related Cogkeys (7). Single Cogkeys would be the least complex to cognitively evaluate resulting in minimal P3 ERP latency and pronounced P3 ERP amplitudes when combined with random non-target stimuli (10). Multiple Cogkeys (8) could include ten images of monkeys, or 8 different 4 note rising arpeggios, or seven prime numbers. The invention limits the number of multiple Cogkeys to a maximum of twelve since adding Cogkeys increases complexity of cognitively differentiating between targets and non-target stimuli. The maximum of 12 is a value beyond which an unacceptable increase in P3 ERP latency may result. The invention allows for imbedded Cogkeys (9) that take the basic image or sound and imbeds it within a larger more complex image or sound (12).

The invention's Stimulus Presentation Unit (SPU) presents at the initial access request, a menu-driven drill-down allowing the user (or system administrator) to create a pre-selected Cogkey stimulus file (CKSF) associated with the user ID. The CKSF contains the user's Cogkey, multiple Cogkeys or embedded Cogkeys (11). The CKSF does not contain non-target stimuli; that is a separate file.

Once the CKSF is created, the invention automatically generates the non-target stimulus file (NTSF) (11). The NTSF is a very large set of random images or sounds automatically selected from the stimulus archive (5) using metadata tags to match the stimulus type. If the Cogkey(s) are a spoken word, the random non-target sounds may be other words, or a combination of words, sounds and music. If the Cogkey(s) are an image of an object, the random non-target images may be images of other objects, or a combination of images.

A large NTSF is created with hundreds of images or sounds for each user. Non-target stimuli are chosen to be clear, unmistakable and not similar to the random stimuli to mitigate semantic overlap. Some semantic overlap is unavoidable. For example, the Cogkey image “Bird,” may produce minor overlap with any random image containing such items as a feather, a cooked thanksgiving turkey or a tree with a nest in it. Semantic overlap may cause a false positive P3 ERP, which is resolved by the invention's statistical processing methodology by averaging many responses.

On initial access request, in conjunction with the system administrator's approval for user access, ACSSECR builds a user profile consisting of user ID, the Cogkey stimulus file (up to 12 stimuli) and the non-target stimulus file (hundreds of random related stimuli). In other embodiments, the user profile may also contain user response data for later comparison, but this is not required.

At each subsequent user access request, the Stimulus Presentation Unit (SPU) randomly selects in real time, stimuli for presentation from the user associated NTSF and 10% to 20% of the time, randomly selects Cogkey stimuli from the user associated CKSF for presentation (20). When the user is Cogging in, they initially see or hear a brief message requesting attention prior to the stimuli presentation, followed by the stimuli, most of which (80%-90%) are random non-targets and 10%-20% of which are Cogkeys. The user will involuntarily respond to the Cogkeys with a P3 ERP. The invention can display images with a short black screen between each image or present the images back to back, or the invention can play audio with a short silence between sounds or present them back to back. To limit distraction, all images are edited to exactly fit the screen with the same brightness and all sounds are presented at the same volume.

The P3 ERP has characteristics that its amplitude is positively correlated to the recognition of a task relevant stimulus and inversely correlated with target stimulus frequency. ACSSECR takes advantage of both these characteristics. The selected Cogkeys are the target stimulus and the random stimuli are the non-targets. The subject's relevant task is to recognize Cogkeys which are presented infrequently but take no action on that recognition. The system security policy may request that users mentally count the number of Cogkeys presented, as this additional cognitive function may enhance P3 ERP responses. To take advantage of the inverse correlation of target frequency and P3 ERP amplitude, a large number of stimuli are presented to the subject in rapid succession with a small number of them being Cogkeys.

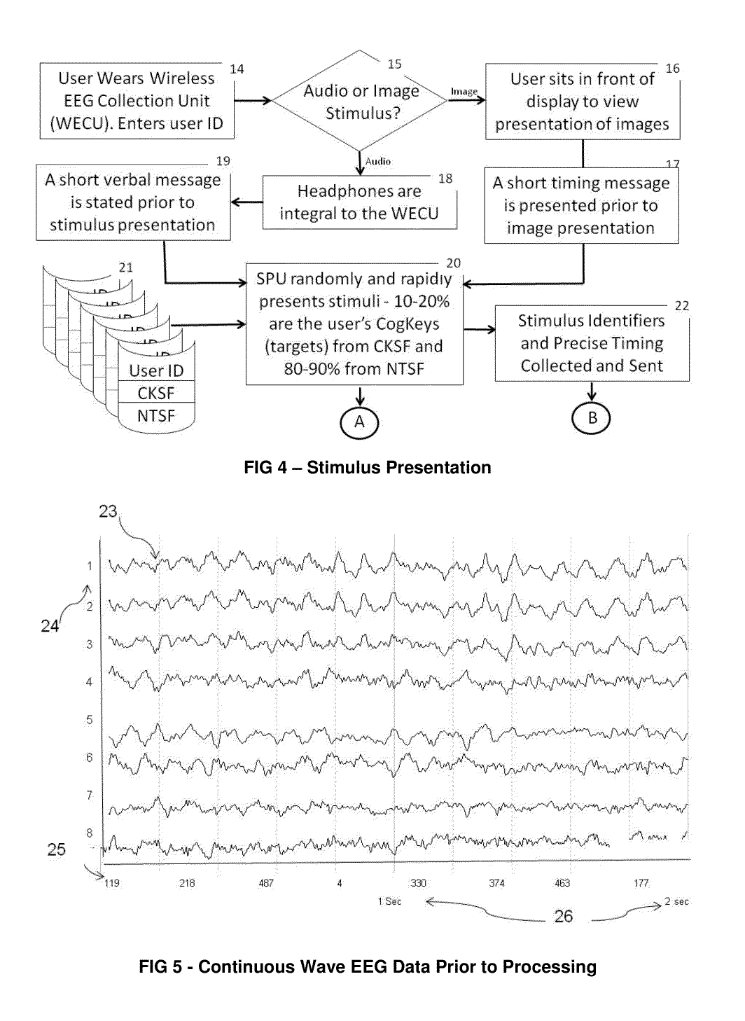

FIG. 4 shows the functional flow of the stimulus presentation, starting with the user wearing the Wireless EEG Collection Unit (WECU) (14), and the system recognition of the audio or image stimulus type based on the user profile (15). If image stimuli, the user sits in front of a screen to view the stimuli (16) starting with a short message presented to get the user ready (17). If the stimuli are audio, the sound clips are presented through headphones, but the preferred embodiment still has the user sitting to minimize body movements which create irrelevant EEG spikes (18). A short verbal message is presented to get the user ready (19).

The SPU selects Cogkeys randomly from the Cogkey stimulus file (CKSF) and the non-targets from the NTSF (21) with a ration of 10-20% Cogkeys and 80-90% random non-targets (20). Stimuli are sequenced by the SPU and presented (images or audio) and stimuli numbers and other coding is sent to the EEG collection computer (22) so that the image identifier and timing can be correlated with the EEG waveform data. The precision timing and stimulus identifier are used to relate the cognitive responses to the specific eliciting stimulus.

FIG. 5 is an example of eight channels of raw EEG data (23) numbered one through eight (24) along the y-axis. The raw EEG data is received by the processing function. The stimulus identifiers (25) are shown on the bottom of the chart (x-axis) above the timing (26). The stimulus identifiers are one or two digit identifiers for Cogkeys (numbers 1-12) and three digit identifiers for non-target stimuli (100-999). Matab has an open source product called EEGLab that provides tools for stimulus presentation and timing. “Presentation” is a commercial product that provides stimulus delivery and timing, produced by Neurbehavioral Systems. The code written for this invention used standard pre-written algorithms which were customized to provide the unique features required to achieve the capabilities not available in the prior art.

### EEG Data Collection

The invention uses non-contact or dry electrode internally amplified EEG sensors. The design of these sensors is not part of the invention, but a discussion of recent innovation in the development of these sensors can be founded in recent publications including the 2010 IEEE publication, IEEE Reviews In Biomedical Engineering, Vol. 3, containing the paper, “Dry-Contact and Noncontact Biopotential Electrodes: Methodological Review”. Dry electrodes use spring-loaded contacts that push through user's hair to make contact with the scalp. Non-contact sensors use an internally amplified sensing plate that does not touch the scalp. There are a few non-contact EEG sensors on the market (eg., http://www.quasarusa.com/technology sensors.htm, and http://www.neurosky.com/\). There are also a variety of patents for non-contact sensors, including: 20110043225 and US20120265080, and recent publications discussing wireless brain-computer interfaces (BCIs), such as: http://dx.doi.org/10.5772/56436

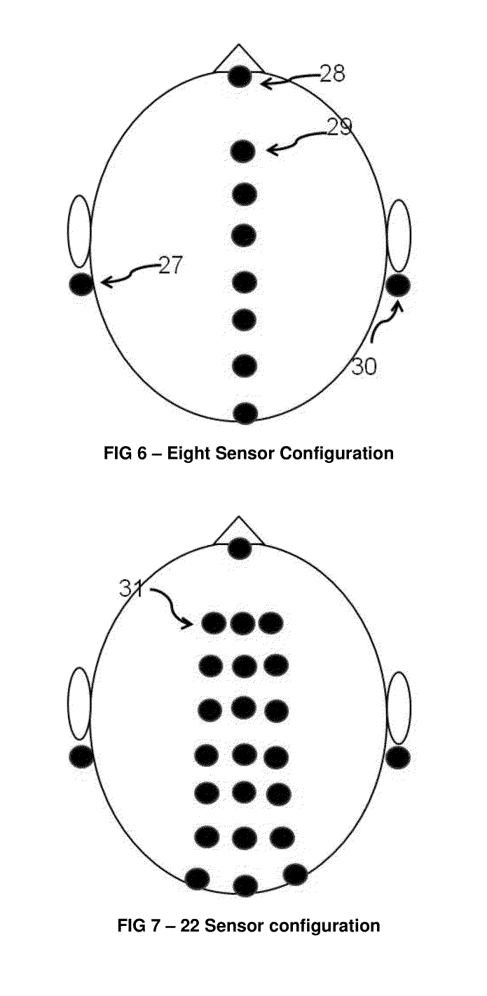

This invention places the internally amplified EEG sensors in a configuration ideal for collecting P3 ERPs. FIGS. 6 and 7 show two such configurations. The invention collects real time EEG data from a minimum of one collection sensor preferably in the center of the scalp. More sensors reduce overall Signal to Noise Ration (SNR) but add processing complexity. The two configurations in FIGS. 6 and 7, use 8 and 22 EEG collection sensors respectively (29, 31). In addition to collection sensors, the invention uses two mastoid (behind the ear) sensors (27, 30), whose input is averaged for use as a reference, as well as a sensor at the top of the forehead used to detect eye blink (28). Eye blink is an artifact that causes interference in EEG collection. The invention uses data from the eye blink sensor to detect that artifact so that data collected during and around the eye blink event can be removed. The eye blink sensor is also used as a data sensor for periods when eye blinks are not detected.

Eye blink is the most significant EEG collection interference factor, resulting in large irrelevant potential spikes or artifacts. Eye movements are called saccades which generate transient electromyographic voltage potentials called saccadic spikes. Eye blink occurs several times per minute and eye movement several times per second. Eye blink interference creates signal responses prominent in the frontal lobe with amplitudes over 100 μvolt. These artifacts are significantly larger than cerebral potentials and are detected and removed by the invention automatically by the algorithm during data processing. To detect these spikes, typical EEG collections use three electrodes are usually placed around one of the subject's eyes (the Horizontal Electrooculography (HEOG) and Vertical Electro-oculography (VEOG) channels). This invention removes the high level of intrusion associated with HEOG and VEOG channels and uses a single sensor located on the scalp near the forehead (28, 33). This sensor is called FP_{z} in the Modified Combinatorial Nomenclature (NCM) electrode naming system. It is close enough to the eye to detect the significant spikes caused by eye blinks. FP_{z} is also used by the invention as an additional collection sensor.

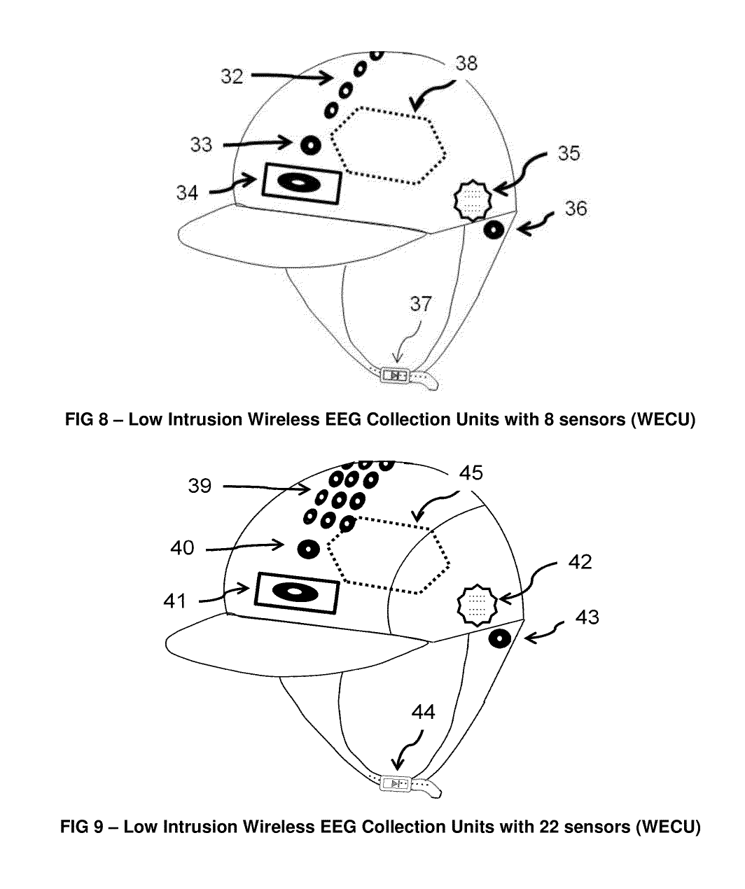

FIGS. 8 and 9 depict the preferred embodiment with collection sensors (32, 39), eye blink sensor (33, 40) and mastoid references (36, 43) sewn into a common brimmed sports cap. This apparatus is referred to by this invention as the Wireless EEG Collection Unit (WECU). This embodiment introduces an alternative to typical EEG eye blink sensors that are intrusively placed around the subject's eye. Sensors placed on the scalp close to the forehead are very sensitive to eye blink, and for the purpose of identifying and eliminating this interference factor, these provide a minimally intrusive approach. The invention also has a wireless transmitter (34, 41) that can be Bluetooth or IR, internal headphone (35, 42) for audio stimulus, and a chin strap (37, 44) that allows the cap to be secured very tightly to bring the EEG sensors as close to the scalp as possible. Bluetooth can support over 700 kb/s and IR transmission uses a variety of coding schemes with peak data capacity in the GigaIR protocol specification of over 1 Gb/s with a range of several meters.

Shown as a dotted line in FIGS. 8 and 9 (38, 45) at the back of the WECU are the battery pack, circuitry to digitize the and wirelessly transmit the sensor data. Sampling rate in the preferred embodiment is 500 Hz per channel, including the reference sensors and eye blink sensor, allowing capture of EEG artifacts. A low Noise digital to analog (D/A) converter for each channel provides 24 bit resolution in the preferred embodiment. Also represented by the dotted line at the back of the cap is the circuitry to multiplex the data from all sensors, including the eyeblink sensor and reference sensors onto the IR or blue tooth wireless carrier.

The Invention also uses the cap-mounted Bluetooth or IR device to receive data for any audio stimulus used. The sound clips presented through the cap-mounted speakers (35, 42) are transmitted from the presentation algorithm to the cap-mount receiver (34, 41) and digital to analog converted to deliver the audio stimuli.

The wireless EEG collection units (WECUs) depicted in FIGS. 8 and 9 are examples of the preferred embodiment of this invention, but other sensor-containing devices may be used, such as a headband (e.g., http://www.engadget.com/2013/05/18/axio-melon-eeg-headband/), visor (e.g., http://www.engadget.com/2010/12/26/neurosky-sticks-eeg-sensors-in-a-golf-visor-sells-it-to-japanes/), or other cap-contained configurations (http://www.isn.ucsd.edu/pubs/iscas08 eeg.pdf). These other alternatives may not provide the embedded audio speakers of the preferred embodiment, and may digitize the analog EEG data in a different format. These differences can be accommodated by small changes to the invention.

### EEG Data Processing

The invention uses a number of individual algorithmic steps in the processing of collected EEG signals to get an authentication CL. All of these steps are automated and run in real time. The values (e.g., sampling rate, number of sensors, stimulus presentation frequency, etc.) described in these steps are examples and may be varied to optimize the design for different embodiments. Some of the values are programmed into the system by the system administrator. The invention provides a high level menu of parameter selections that may be used by the system administrator to optimize the ACSSECR authentication system. Examples of administrator menu selection items are (menu can be modified to meet organizational needs):
Select the number of different but related target stimuli: 1 to 12 (3-5 recommended for image stimuli. Just one recommended for audio stimuli. Higher number helps mitigate shoulder surfing if stimuli are images)
Select static or dynamic stimulus presentation rates (Dynamic allows the system to slow down if the user is not recognizing targets or speed up if the user is responding to all stimuli perfectly
Select initial Stimulus duration (msec): any whole number 50-250 (150 msec recommended. Use higher number if large number of target stimuli selected or for embedded targets) and Select initial ISI (msec)—e.g., 600 down to 300 (500 msec recommended. Lower ISI results in faster processing but potentially more false negatives. Lower ISI for subsequent access requests after initial successful access)
Select the number of non-target stimuli: 100 to 500 (based on required confidence level (CL), larger number for higher CL)
Select required CL for authentication complete: (recommend 95% for standard network system, 99.9% or higher for high security system)
Select number of stimuli at which if required CL is not reached, test either restarts (can use higher ISI and/or higher stimulus duration to facilitate user recognition of targets) or test ends with authentication not confirmed, access denied.
Select Target percentage—any whole number 5%-25%, (20% recommended. Lower percentage results in more pronounced P3 ERPs, but longer test)
Select absolute CL value or rate of CL improvement to allow access
For authentication and access based on rate of CL improvement, select minimum number of target stimuli responses needed to allow access (10 recommended)

The invention uses several techniques to conduct the biometric testing quickly and to be minimally intrusive. For example, stimulus duration and inter-stimulus intervals (ISI) are kept to a minimum. These minimums are limited by human cognitive processing capacity, but this method has identified an approach for achieving minimums below expected cognitive response times. The P3 ERP typically occurs at or around 300 msec post stimulus. Short ISIs, even shorter than the P3 ERP latency of approximately 300 msec, do not obscure elicitation, detection and cognitive processing of subsequent P3 ERP stimuli. The invention is self-adjusting in the selection of ISI down to as little as 100 msec. At ISIs below 250 msec, special processing is used, such as an application called ADJAR (Adjacent Response), which uses mathematical convolution to remove the distortions from overlapping epochs but requires that those epochs are variable in length. Epochs are the defined recording periods surrounding presentation of the stimulus.

The Invention's EEG Processing Algorithm may reside within a variety of different hardware platforms, such as a smart phone, tablet, desktop or laptop computer, embedded in a vehicle dashboard to restrict access to starting the engine, or at the entry to a facility or SCIF (secure compartmented information facility) space. Each functional element of the processing code is available as an open source component that has been optimized for this invention and may be further optimized for unique operational or organizational requirements. Matlab's open source EEG toolbox for EEG, called EEGLab, has EEG processing tools, including tools for rejecting artifacts including eye blink. Compumedics Neuroscan makes a product called SCAN that is a leading software tool designed for processing EEG.

P3 ERP latency increases with subject age, but the signal is relatively stable with respect to factors such as IQ, depression, physical handicap, and sex. This latency is on the order of microseconds, so the sum of those latencies across all collected responses does not result in a noticeable increase in completion of the authentication for older individuals. P3 ERP amplitudes decrease with stimulus familiarity, which is one reason why methods that record P3 ERP (or bulk brain activity) for subsequent comparative authentication is not practical. Factors impacting P3 ERP amplitude do not impact this invention since the comparative authentication uses current rather than recorded biometric data.

The invention is designed to contain all stimulus presentation, EEG collection and processing software on a single platform, such as a smart phone, tablet computer, laptop or processor embedded in a device, vehicle, facility entrance or any place or system requiring strict access control. Since body movement creates EEG interference, the invention provides optimal response when the user sits comfortably in a chair and remains still during the authentication process. If the stimulus is audio, WECU cap mounted speakers will present the sound clips. If the stimuli are images, the invention produces the optimal response when the display is at user eye level and close enough for the unimpeded observation of all presented images without distraction. This optimal distance differs between a smart phone (˜6-8 inches), tablet (12-14 inches), laptop display (˜18 inches) and desktop monitor (˜24-36 inches depending on the monitor size). For vehicle access, the invention assumes the user is sitting in the vehicle. For facility access, the invention allows for wall mounted viewing of stimuli (if images) with a chin and head rest to keep the head still enough to mitigate movement that could result in irrelevant EEG artifacts.

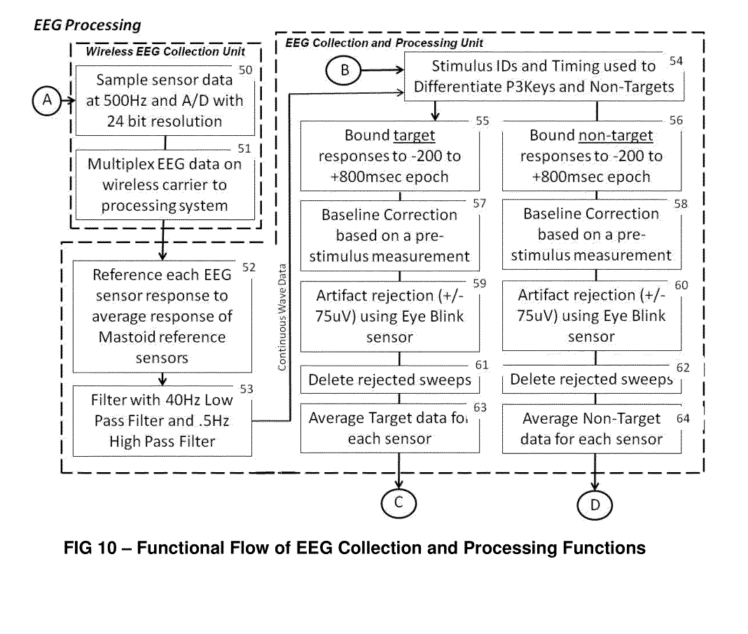

FIG. 10 depicts the invention's flow of the EEG collection and processing functions. The figure has two blocks depicting the WECU and ECPU. Real time sensor data is sampled in the WECU and analog EEG converted to digital data at a rate of 500 Hz. Analog to digital (A/D) is performed with 24 bits resolution in one embodiment (50). Data, including digitized EEG responses, stimulus IDs and precise stimulus timing, is wirelessly transmitting to the ECPU (51). WECU and ECPU processing functions are based on open source (e.g. Matlab/EEGLab) algorithms and customized to meet organizational security objectives

Upon receipt of the digital sensor data, the Invention's ECPU processing function references each EEG sensor response to the average response of the mastoid reference sensors (27, 30, 36, 43), which is the baseline for signal amplitude measurement. The Mastoid reference sensors have low contamination from muscle or electrocardiogram artifacts, making them valuable as reference electrodes from which to measure potential differences for all the other sensors. Other reference locations may be used.

The invention takes the data, having been referenced to the average of the two mastoids (52), through a low pass filtered (LPF) with the preferred embodiment using a 40 Hz LPF to eliminate 50 Hz and 60 Hz electrical noise (depending on region). The data is also passed through a 0.5 Hz High Pass Filter (HPF) to remove any DC offset (53). The filtering retains the data of interest in the 0.5 Hz to 40 Hz frequency range and assures elimination of all extraneous signals unrelated to cognitive processing. The referenced, filtered data results in a stream of continuous wave data, called a .CNT file, for each sensor. After the LPF and HPF, the data is processed as separate target and non-target data streams by the EPU (54). This differentiation can be implemented at other points in the processing chain.

The invention converts .CNT data to useable EEG data using a defined epoch interval. To extract the desired ERPs from the background EEG signals, signal averaging is used, and to perform signal averaging, uniform data blocks are ideal. In the preferred embodiment, the epoch is a one-second data block from −200 to +800 msec (55, 56). Each stimulus is presented to the user at the zero millisecond point in the epoch. The pre-stimulus portion of the epoch (−200 to 0 msec) is averaged and used as the zero line by the invention to baseline correct the post-stimulus measurement (57, 58). The uniform epoch is the basis from which all responses can be averaged. The invention bounds the target and non-target responses separately. Target epochs are identified numerically in the range 1-12 to coincide with target identifiers. Non-target epochs are identified in the range 100-999.

Data from the eye blink sensor is used to identify and eliminate artifacts that exceed a specified high absolute amplitude threshold (e.g. +/−75 uV) (59, 60). For each occurrence of such an artifact, data is removed in the time window from −50 to 50 msec around the detected maximum peak of the eye blink. Any epoch containing an artifact of this magnitude within this range is deleted (61, 62) leaving artifact-free epochs in two EEG files: cleaned target epochs and cleaned non-target epochs. At this point there are significantly more non-targets than target epochs because we started with fewer only 20% (for example) target stimuli.

The invention separately averages the cleaned target and non-target epoch data to create averaged ERP files (63, 64). The signal of interest, the P3 ERP, is more easily detected through signal averaging, with responses examined statistically over many trials. Signal averaging also provides the additional benefit of helping to eliminate random EEG noise. The responses are averaged for each sensor to find the peak sensor, but then the method uses each epoch for the peak sensor to calculate confidence levels. At this point, there is a single target and a single non-target average stimulus response value for each sensor. Like many of the processing steps, the averaging algorithm is not part of this invention design, but is open source signal averaging code.

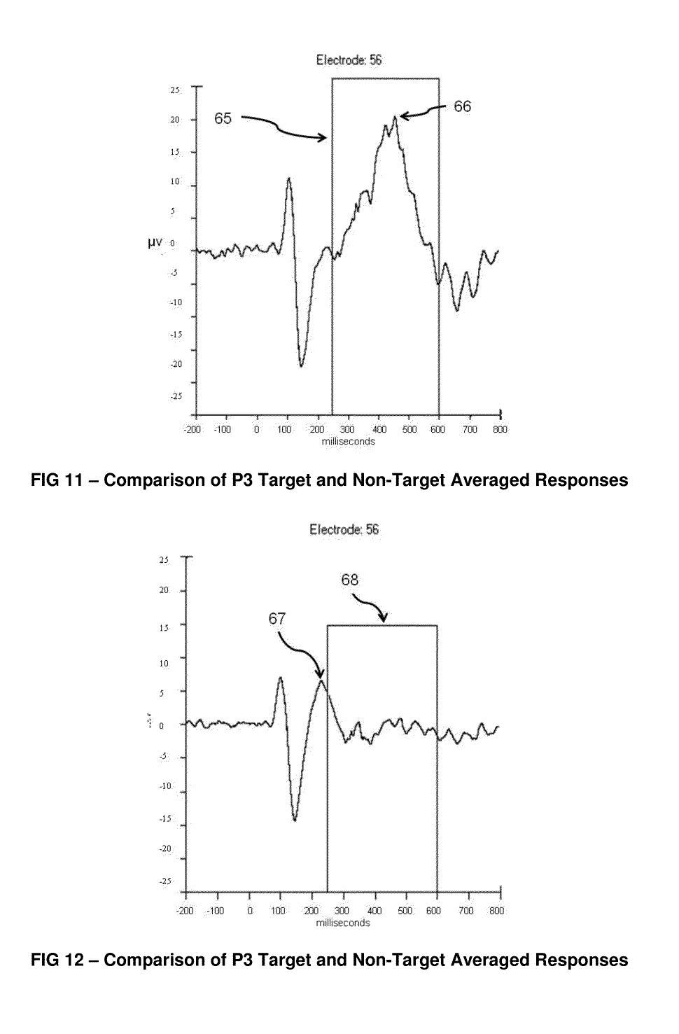

FIGS. 11 and 12 show examples of target and non-target averaged ERPs exemplifying the difference in amplitude (66, 67). Depending on subjects, target-to-target interval, and level of attention, the P3 ERP may occur anywhere between 250-600 msec post-stimulus. This range is a typical range that is used by the invention in the preferred embodiment as the data analysis window. This P3 ERP analysis range is boxed in the FIGS. 11 and 129 (65, 68).

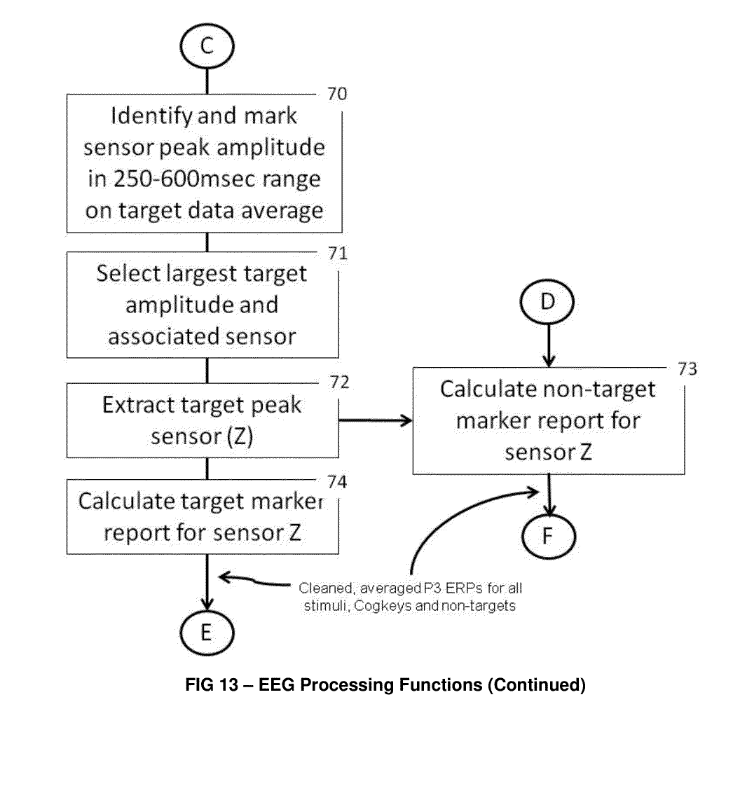

FIG. 12 depicts the invention's next set of algorithmic steps, starting with finding the sensor with the highest amplitude average target response peak inside the selected P3 ERP analysis range (250 to 600 msec). The maximum peaks are identified automatically by open source EEG peak detection software that examines the set of active sensors using the detected targets averaged data set (70). The set of maximum peaks across the set of sensors is sorted to identify the maximum amplitude sensor (71). That maximum amplitude sensor (referred to in the FIG. 13 as “Z”) is used for the remaining calculations of the EEG processing. This is an important element of the methodology: the selected peak sensor will have collected the highest amplitude P3 ERP target response and is compared to the same sensor for the non-target data. That maximum sensor is likely to vary from user to user and for any particular user, may vary from authentication session to authentication session.

The invention then extracts the peak sensor data from the set of active sensors using the clean target epoch file (72). After the epoch file is extracted, a peak detection algorithm detects the peak of each epoch. This is called the target sensor marker report (74). The non-target marker report is also generated (73), using the same sensor that was identified as the peak target sensor. Once the target and non-target sensor amplitude reports are generated, Min and Max values of both data sets are calculated for each data set to validate that the data is within the expected range for EEG measurements. Any data values>50 uV or <−50 uV, are thrown out (75, 76). Once the data set are cleaned, EEG processing is complete and statistical analysis of the data can be performed. The results of the EEG processing steps are the clean (anomalies removed) averaged P3 ERP responses to each stimulus presented, including both Cogkeys and non-targets. This data is then passed to the statistical calculation method.

### Data (Statistical) Analysis and Biometric Confirmation of Identity

The ACSSECR invention produces a CL by performing statistical calculations on the EEG data collected in real time. As the user continues to respond to stimuli, the number of targets (Cogkeys) and non-targets increases, providing increasingly improved CLs (if the user is who they claim to be). The system administrator will have previously set an authentication CL at which the system will allow or deny the user access. For example, if access is approved by the system at 99.4%, once that level is achieved, access is immediately provided. The system can be set to deny access if the CL does not hit 87.5% within 20 seconds. Or the system can slow down the stimuli by increasing the inter-stimulus interval if the CL is improving over the initial 10 seconds, but the user appears to be missing some of the targets. A record of previous user authentication session results can be retained for comparison to set a stimulus duration and ISI optimized for the user, but is not necessary.

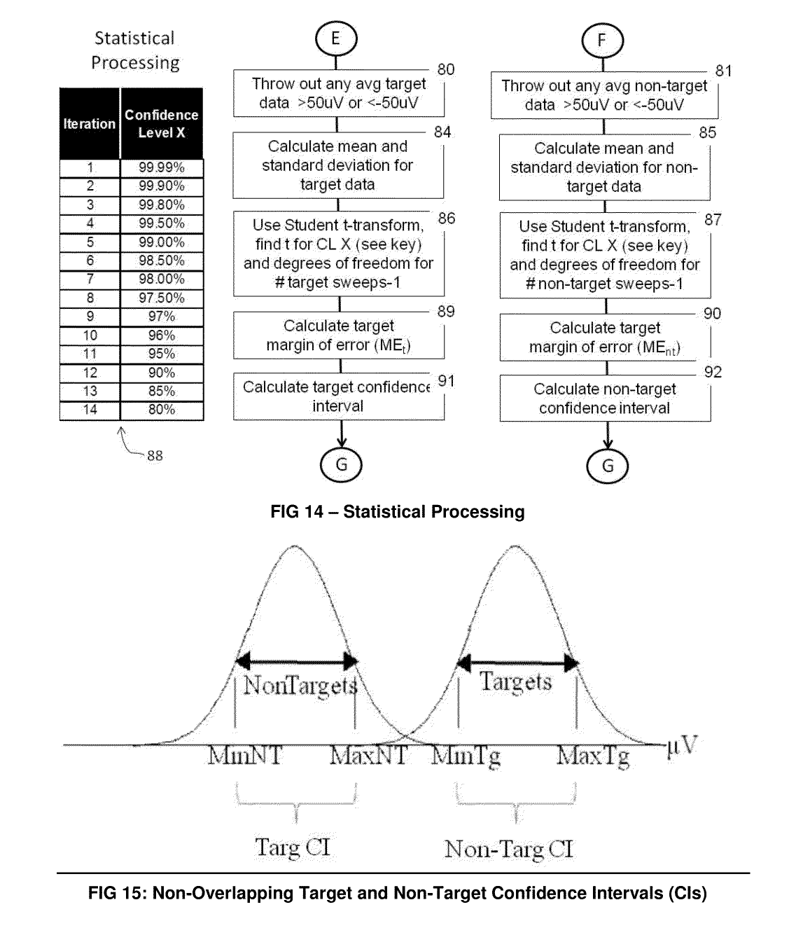

FIG. 14 shows how the statistical processing is conducted by the invention. Note that the invention makes use of open source algorithms for the calculation of confidence intervals which have been optimized for this invention and are run automatically. Confidence Intervals (CIs) should not to be confused with confidence levels (CLs). As shown in FIG. 15, CIs are ranges. The non-target CI is the range between the minimum non-target (Min_{NT}) and maximum non-target (Max_{NT}) values, and the target CI is the range between the minimum target (Min_{Tg}) and maximum target (Max_{Tg}) values. CLs are statistical values expressing authentication confidence and have values such as 99.99%, 99%, 98%, etc.

The invention verifies that the subject recognized the presented target stimuli as their Cogkeys and that presented non-target stimuli are not recognized as such. To confirm that the collected data exhibits higher P3 ERP amplitudes for target stimuli with sufficient confidence (CL) a real time statistical analysis is conducted to make sure there is no overlap between target and non-target CIs.

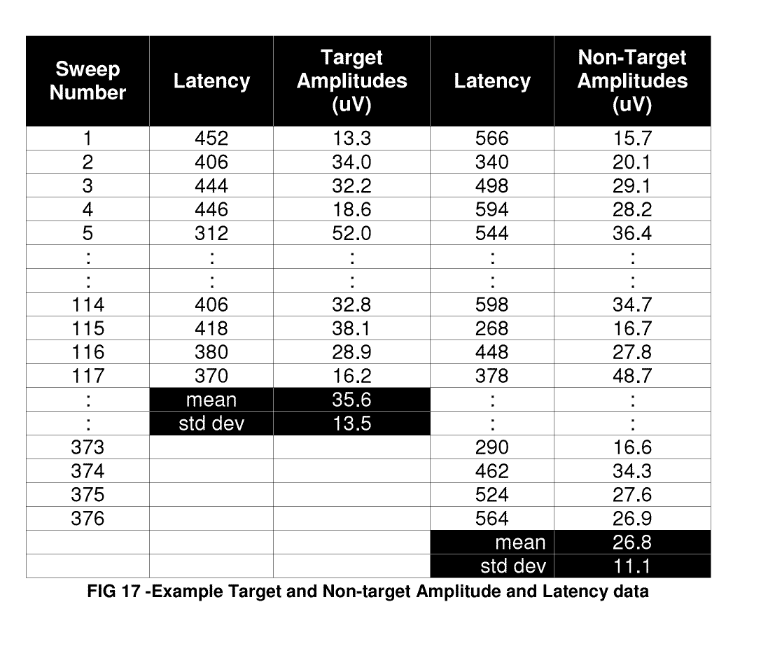

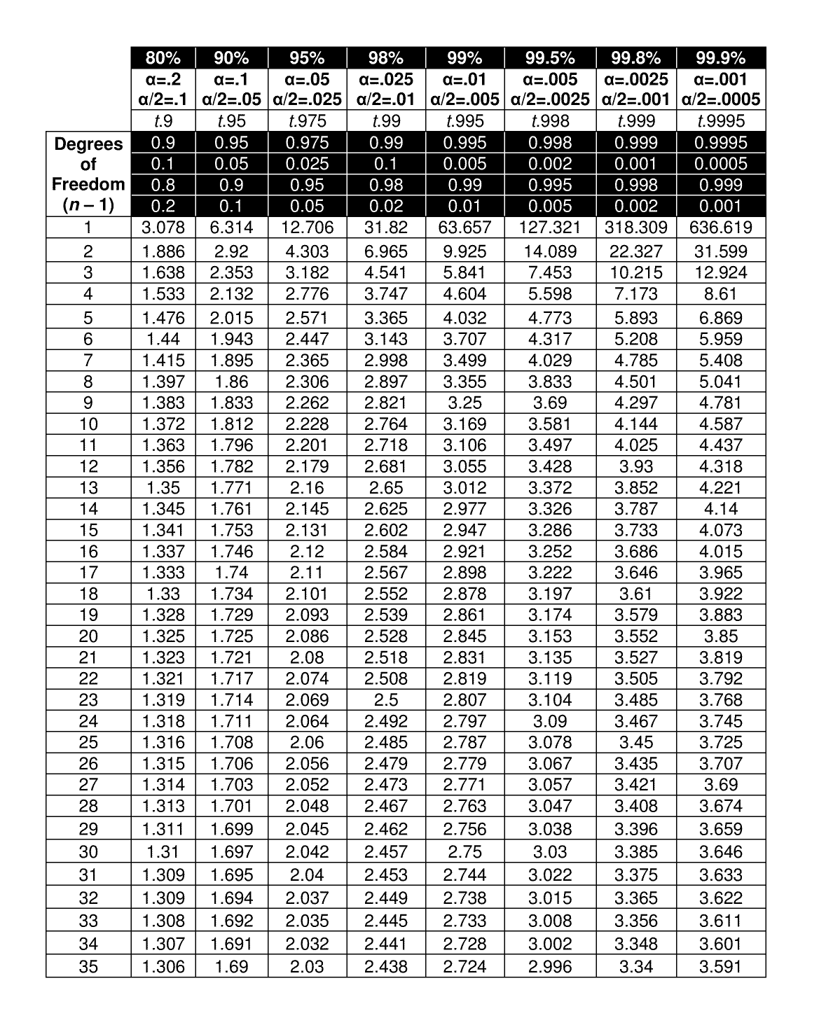

The latency and amplitude measures for each EEG sweep are stored (FIG. 17). The analysis of this data makes use of the mean and standard deviation values to calculate confidence intervals.

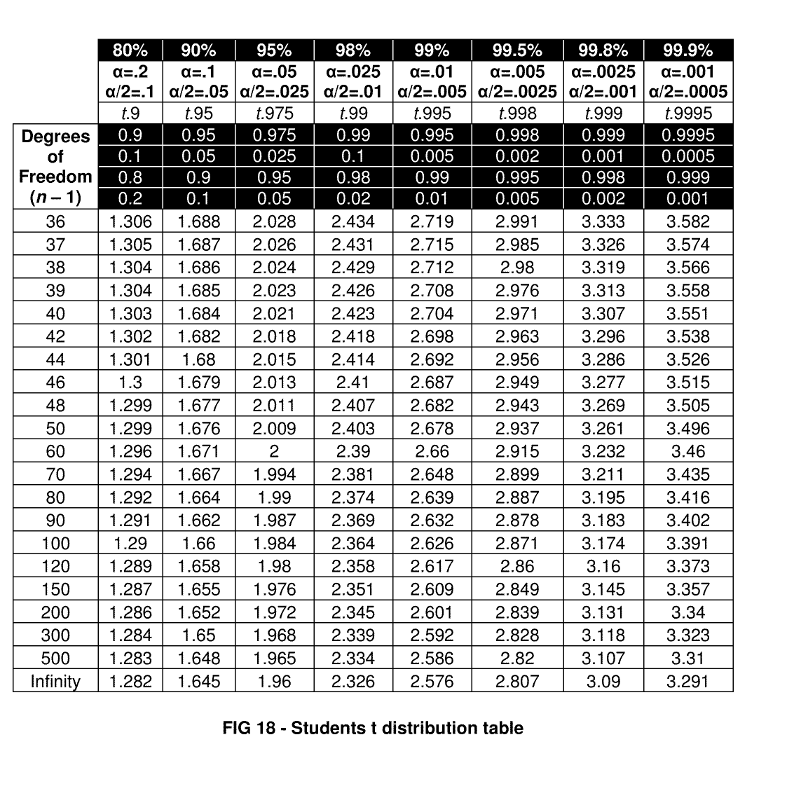

The invention makes use of Student's t distribution (FIG. 18), which is designed for estimating and assessing the statistical significance of two sample means of normally distributed populations where the sample size is small. The ACSSECR target and non-target data sets fit the criteria for small sample size, and normal distribution of EGG data was verified. The following equations are used to calculate margin of error, mean (average) and standard deviation (84, 85):

$$ME = {t}_{\frac{α}{2}} ( \frac{s}{\sqrt{n}} )$$

$$\overline{x} = {\sum }^{ } x / n$$

$$s = \sqrt{{Σ ( x - \overline{x} )}^{2} / ( n - 1 )}$$

Starting with the highest CL (99.99%), the target and non-target confidence intervals are calculated using these equations:

Target_{high}=mean_{targ}+ME_{targ}

Target_{low}=mean_{targ}−ME_{targ}

Non-target_{high}=mean_{NT}+ME_{NT}

Non-target_{low}=mean_{NT}−ME_{NT}

Target and non-target CIs overlap if Targ average−Margin of Error<Non-Targ average+Margin of Error. If there is overlap, the CL is decreased incrementally. For example, for high resolution of CL, the intervals might be 99.99%, 99.9%, 99.8%, 99.5%, 99%, 98.5%, 98%, 97% 96%, 95%, 90%, and finally 80%. The CL is reduced until the intervals do not overlap. If there is still overlap at the 80% confidence level, discrimination between target and non-target might be too low to assure identification, but the lowest acceptable value can be set by the information system administrator.

Since Target responses (P3 ERPs) have higher amplitude on average than non-target responses (which either lack a P3 ERP or have a lower amplitude P3 ERP), the subject's ability to differentiate between target and non-target stimuli is demonstrated when the CIs are distinct and non-overlapping within a specified CL and MinTg>MaxNT (FIG. 15). The following are the individual statistical analysis steps used by the invention to calculate a real time confidence level shown in FIG. 14:

For both target and non-target data, the invention calculates the mean and the standard deviation of the amplitude (mean_{targ}, mean_{NT}, S_{targ}, S_{NT}) (84, 85):

The invention uses the Student's t distribution tables to select the value of t for Confidence Level X (starting with 99.99%) and degree of freedom equal to number of target sweeps minus 1: n_{targ}−1. The invention also select the value of t for CL X (again, starting with 99.99% (88)) and degree of freedom equal to number of non-target sweeps minus 1: n_{NT}−1 (86, 87, 88).

The invention calculates two margins of error (ME), one for the target data (MEₜ) and one for the non-targets (MEₙₜ). The margin of error uses the sample mean, the sample standard deviation, s, and the t distribution (other distributions can be used), where n is either n_{targ} or n_{NT} and equal to the number of peaks measured in the target and non-target data sets respectively. The invention calculates target and non-target margins of error (ME) using t_{α/2}(s/√n) where n=either n_{targ} or n_{NT} (89, 90).

The invention calculates the target confidence interval=mean_{targ}+ME to mean_{targ}−ME and non-target confidence interval=mean_{NT}+ME to mean_{NT}−ME. (91, 92).

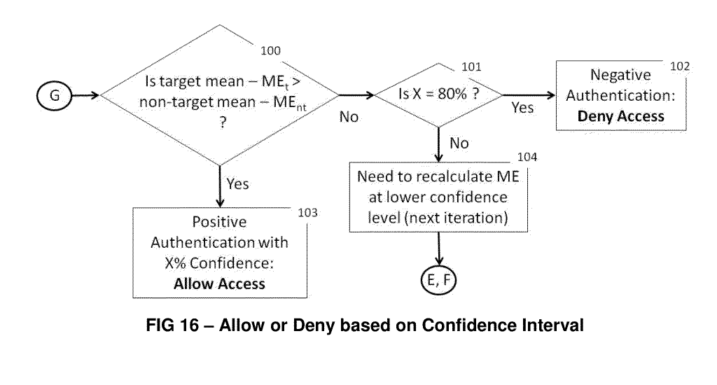

As shown in FIG. 16, if Target_{low}>Non-target_{high}, there is a confidence level of X% (starting with 99.99%) that we can differentiate between target and non-target responses allowing us to verify the identity of the subject (100). Authentication is then complete and access is allowed (103). If Target_{low}≦Non-target_{high} (where Target_{low}=mean_{targ}−ME and Non-target_{high}=mean_{NT}+ME), the invention will recalculate margins of error at lower confidence levels (104), unless we have reached the system defined lowest allowable confidence level (101). As To recalculate at a lower CL, we go back to E and F (84, 85 claims). This is repeated until Target_{low}>Non-target_{high} or until CL=80% (or whatever the system lowest CL is) and still did not result in Target_{low}>Non-target_{high}. In this case, authentication is negative and access us denied (102).

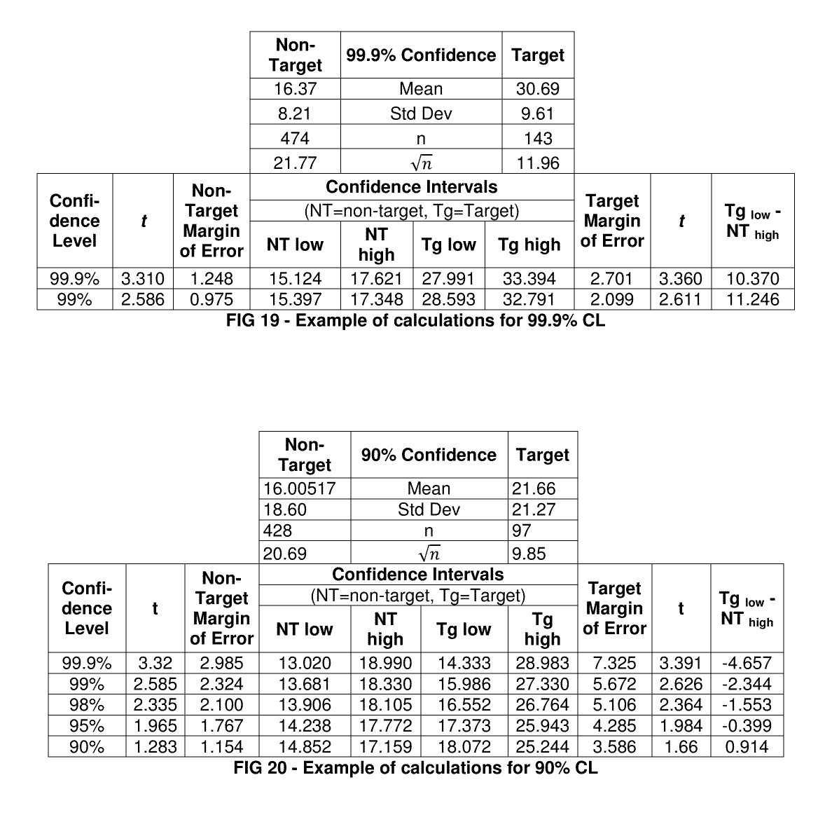

FIG. 19 shows the calculated values and the resulting confidence level (left bottom of table) for a 99.9% CL. This example shows margin of 10.4 μV between the target and non-target confidence intervals at the 99.9% CL and more than 11 μV of separation for the 99% CL (right bottom of table). FIG. 20 shows insufficient difference at the 99.9% CL between targets and non-target ranges. There is overlap between the maximum non-target and minimum target measurements for CLs above 90%. This example demonstrates an inability to conclusively determine if a target or non-target was measured with confidence >90%. To resolve this, the system may be set to either deny access or continue with a greater number of measurements. More samples increases the degrees of freedom, in turn reducing the margin of error and providing better discrimination between targets and non-targets for the desired higher CL. The authentication system administrator decides whether to re-test a subject at or below 99%, 90%, or 80% (or any value) depending on the security required for the system.

The invention allows the system administrator to select either an absolute CL to allow access or a rate at which the user's CL is improving. A very high CL is desirable for a biometric (common biometrics offer from 95% to 99.99% accuracy), with a 99.9% CL or better preferred. To attain this level, a large number of measurements are used to reduce the margin of error, which is at odds with the desire to reduce the time of evaluation. For example, if the user's P3 ERP response to every target is very robust, and non-existent for every non-target after 50 stimuli are presented (10 targets, 40 non-targets), the system can be set to allow access even if there have been fewer than 20 target data points. Since P3 ERPs are signal averaged for best results, reducing the number of targets provides diminishing returns. Ten is about the lowest value that can be expected to provide adequate confidence. Ten targets at 20% target percentage is 50 stimuli total.

The invention treats measurements outside the target confidence interval as false negatives since they are greater in amplitude than the maximum range of the confidence interval. It is common practice to discard data outliers that are outside the range of +/−2 sigma from the mean. If significant outliers appear in target or non-target data, outside the normal P3 ERP amplitude range, the invention discards that data prior to including the data in the real time analysis.

A user may react to stimuli not correlated to their Cogkey if the stimuli is familiar and unexpected. Averaging of data usually resolves this issue but for very small numbers of stimuli, the impact of a single false response could have an impact. If the data contains a significant number of false positives (large amplitude P3 ERPs to non-target stimuli), or false negatives (lack of recognition of targets) then an erroneous result might is reported, with either denial of access or the need for continued presentation of stimuli.

The Invention's statistical analysis algorithm may be refined in several ways. In the simplest embodiment, the Primary Peak Sensor Method identifies the sensor with the peak average target response and uses that sensor to compare the target and non-target responses. The mean, and the standard deviation of the n responses are calculated to obtain margins of error and confidence intervals. This method is the only choice if the EEG sensor configuration used consists of only a single sensor. This method is simple and very effective for systems that do not require an absolute minimum of measurements, and fast authentication time.

In the preferred embodiment, the Multi-Sensor method is used to increase the number of sensors used (the number depending on the EEG sensor configuration used). For example, the seven sensors along the center of the scalp (The NCM nomenclature refers to these as: FPz, Fz, FCz, Cz, CPz, Pz, POz, and Oz) provide an outstanding averaged response (FIG. 6). These sensors run the length of the subject's head from back to front along the line of the interparietal suture, the anterior fontanelle and the frontal suture of the skull. For each ERP response sweep, the group of sensors data is averaged, so the value of n does not increase, but the Signal to Noise Ratio (SNR) does increase and the standard deviation correspondingly decreases, typically providing an improved separation of target and non-target confidence intervals. The invention uses this approach to improve the SNR as long as there are multiple sensors in the collection configuration. It is important that the sensors are adequately spaced to mitigate correlation effects. The farther the sensors are from one another, the lower their correlation. The standard placement shown in FIG. 6 has satisfactory low correlation.

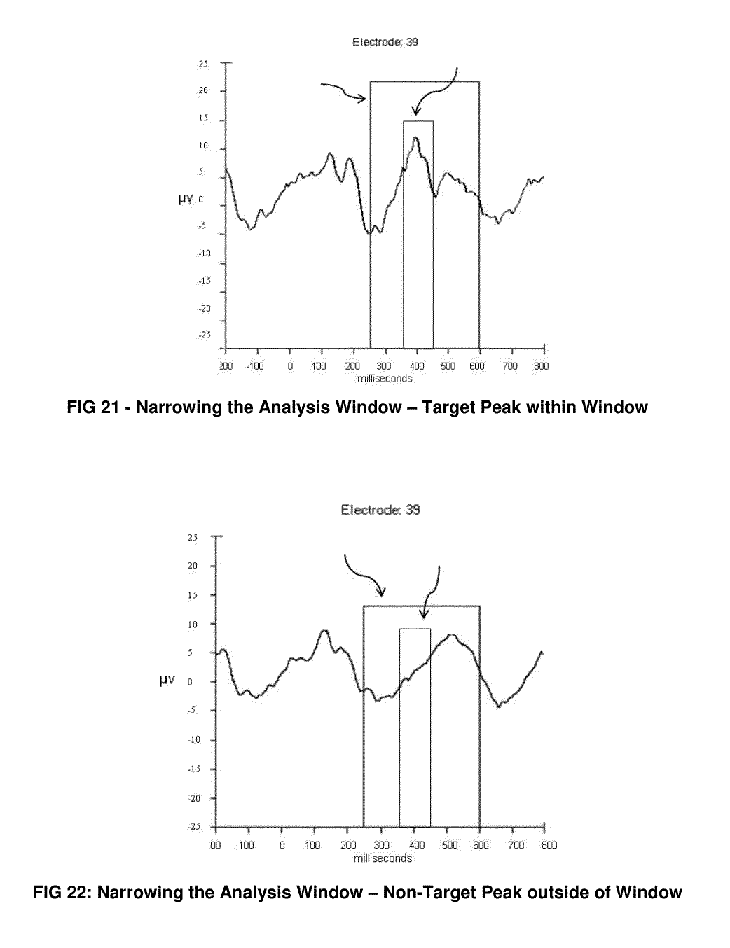

A third data analysis method used by the invention is the Peak Detection Interval Reduction which makes use of the standard deviation of the target response peak latency. This method narrows the peak detection window (FIGS. 21 and 22) with little impact on the average target amplitude, but substantial decreases in average non-target amplitude, by removing artifacts such as late P2 responses from the non-target detection window. The average target peak amplitude latency is measured and, rather than use a wide target peak detection window (e.g. 250-600 msec) a narrow peak detection window is used (e.g +/−10 msec, +/−20 msec, +/−30 msec, etc.). This method is used to improve separation of target and non-target confidence intervals. This method provides better results for smaller number of trials and faster authentication.

The invention reduces the time it takes to authenticate and gain access, by reducing the number of stimuli presented and correspondingly the number of measurements required, by performing the calculations rapidly and with very fast stimulus sequencing. To accomplish this, the analysis can use the median target peak latency of a set of sensors and use a narrow peak detection window around that median peak latency point (e.g. +/−20 msec) for both the target and non-target averages. A subset of the sensors can be used by selecting those with a minimum difference between target and non-target amplitude (e.g. 3 μV, 5 μV, etc.).

In operational environments, a consistent analysis method is used but the variation in analysis methods provides examples of how elements can be optimized to meet stringent system requirements. In one embodiment, the invention uses several analysis methods sequentially for user re-testing, starting with the most rapid method, moving to a second more precise but slower method if CL<95%, to a third method if CL is again <95% and finally to a final method that may be slow, but facilitates user responses in an effort to get challenging user data (poor cognitive response from mentally challenged individuals) to fit within a required demanding CL.

In another embodiment, the invention can provide dynamic user authentication that periodically re-authenticates while the system or device is in use, by periodically displaying a window in the corner of the screen containing a set of target and non-target image stimuli, or producing target and non-target audio stimuli. Re-evaluation would not be as thorough as initial authentication, but can be used to make sure the same user is still using the system.

The ACSSECR invention is a unique methodology that provides identity authentication within a prescribed CL without detailed (P3 ERP) waveform analysis, subject training or storage of biometric data. The biometric measurement is the comparison of the subject's target peak amplitude response to non-target peak amplitude response (in the same detection window), to confirm the identity of the subject. The system provides authentication confidence levels in the range of 99% to 99.99%.

1. A system and method for authenticating an individual using stimulus evoked cognitive response and real time calculation of an authentication confidence level, to control access to information, systems, devices, vehicles, and/or data, comprising:
a. Methodologies for acquiring, generating and presenting stimulus, collecting and processing electroencephalogram (EEG) data, extracting the P3 Event Related Potential (ERP) signal of interest, statistically analyzing the processed and cleaned P3 ERPs, and calculating a real time authentication confidence level
b. A method for presenting stimuli to a user in a manner that elicits a measurable cognitive response in the form of a P3 ERP
c. A method for eliciting P3 ERPs from users by presenting stimuli with a small percentage of the stimuli associated with the users target stimulus.
d. A method for differentiating between infrequent target stimuli known only to the user and random more prevalent non-target stimuli such that comparison of target and non-target responses can be used to authenticate the user
e. A Stimulus management function that includes collects, metadata tags, categorizes and stores stimuli, provides a menu for user selection of stimuli, a stimulus filing system with user-specific target and non-target files for each user, and a stimulus presentation algorithm that presents target and non-target stimuli to the user while simultaneously sending stimulus identifiers and precise stimulus presentation timing to the EEG processing unit
f. An apparatus to collect real time EEG analog data, convert it to digital data and transmit that data wirelessly to the EEG collection and processing unit, and optionally provide present audio stimulus to a user
g. An EEG Collection and Processing function that receives all sensor data, including mastoid references and eye blink sensor data from the stimulus presentation function and converts the raw EEG data into cleaned P3 ERPs associated with each stimulus presented for subsequent statistical analysis
h. A Statistical Analysis Algorithm that constructs confidence intervals using a normal distribution, such as Student's t distribution, for the averaged target and non-target data sets to find the highest confidence level within which the target and non-target confidence intervals do not overlap.
i. An Access Control Unit that allows or denies access to the user in real time based on the ongoing calculation of confidence levels

2. An apparatus according to claim 1 that embeds in a cap, one or more non-contact or dry internally amplified EEG sensors positioned along the center of the scalp, internally amplified mastoid reference sensors positioned behind the ears, one or more internally amplified eye blink sensors positioned on the scalp close to the forehead, a chin strap to tighten the unit thereby bringing the sensors as close to the scalp as possible, a battery pack to power the electronics, an IR or Bluetooth wireless transmitter/receiver, an Analog to Digital converter tied to each sensor, a multiplexor to put the real time sensor EEG data on the wireless carrier to transmit wirelessly to the EEG collection and processing unit, optional headphones and an optional digital to analog converter to convert digital audio to sound.

3. A method of claim 1 to manage stimulus that includes an internet search agent for collecting stimuli, a stimulus database for storing collected stimuli, an automated metadata tagging algorithm to tag the collected stimuli, a stimulus storage control function for categorizing stimuli based on metadata tags, a menu-driven stimulus selection algorithm through which users selects stimulus categories and a target stimulus, a stimulus filing system with target and non-target stimulus files for each user, and a stimulus presentation algorithm that presents target and non-target stimuli to the user with defined percentages of each while simultaneously sending stimulus identifiers and precise stimulus presentation timing to the EEG processing unit for correlation with collected user stimulus responses

4. The method of claim 3 whereby the stimulus management function collects, processes, stores and presents audio, visual, olfactory and/or tactile stimuli that may include, but not be limited to images of objects, scenes, faces, animals, colors, signs, patterns, numbers, equations, abstract images, drawings, geometric shapes, physical properties (e.g., liquid, solid, gas), still images from movies, sounds, voices, spoken words, environmental noises, computer generated sounds, music, audio clips, olfactory stimuli, tactile stimuli or a mixture of any of these.

5. The method of claim 3 whereby the system has a stimulus presentation unit that includes:
a. A target stimulus file associated with the user ID that contains the user's target stimulus, multiple target stimuli or embedded target stimuli
b. An automatically generated non-target stimulus file, based on the user-selected target and stimulus database metadata, containing random non-target stimuli similar in type to the selected target stimulus (e.g. image, sound, etc.)
c. An optional user file containing a record of previous user authentication session result timing to set an initial stimulus duration and ISI optimized for the user.

6. A method of claim 1 whereby the system elicits ERPs with no user training, no user enrollment, and no storage of user biometric data

7. The method of claim 1 whereby all system components, including administrative functions, the stimulus database, user files, stimulus presentation, EEG processing, statistical analysis and user access control, is contained on a single processing platform which may be any one of a variety of different hardware devices, such as a smart phone, tablet, desktop or laptop computer, or embedded processor in a vehicle dashboard or at the entry to a facility or secure office space

8. The method of claim 1 whereby the system provides an administrative management function used by the system administrator to optimize authentication processing, and meet organizational or operational requirements, allowing menu selection of system parameters including:
a. Either a single or multiple (up to a dozen) related target stimuli
b. Static or dynamic stimulus presentation rates
c. Initial Stimulus duration
d. Initial Inter-stimulus interval (ISI)
e. Target percentage
f. Number of non-target stimuli
g. Required confidence level (CL) for authentication complete
h. Number of stimuli or amount of time at which if required CL is not reached, either deny access or authentication restarts
i. Absolute CL value to allow access or rate at which the user's CL is improving to allow access
j. For authentication based on rate of CL improvement, select minimum number of target stimuli responses needed to allow access

9. The method of claim 1 whereby a simple pre-determined system generated and user known stimulus is used as the system-provided initial target “that must be changed” by the user after initial system access.

10. The method of claim 1 where by the system calculates the amplitude of a subject's averaged ERP response to the target stimuli and statistically compares it to responses to non-target stimuli.

11. The method of claim 1 whereby the system rapidly presents stimuli (very short stimulus durations and inter-stimulus intervals) at a rate approaching the limit of human cognition to quickly authenticate users by using narrow waveform analysis windows around the target response peak latency to extract useable P3 ERP data despite potential cognitive response overlap

12. The method of claim 10 whereby the system rapidly presents a minimal number of stimuli to authenticate individuals in a short time for most individuals, and for difficult to authenticate individuals, allows automatic re-testing with slower stimulus presentation (longer stimulus duration and inter-stimulus intervals), more stimuli or longer authentication duration to meet the system required confidence level

13. The method of claim 1 whereby the system presents target stimuli used as a “key” to elicit an involuntary cognitive response such that:
a. Targets are only known by the user and the access control system
b. Involuntarily cognitive response are elicited from user upon recognizing targets and either no response or a reduced amplitude response to non-targets stimuli.
c. Use of multiple related targets can be used with minimal degradation to recognition response amplitude.
d. Target stimulus concealment (protection from social engineering, shoulder surfing) by embedding target stimuli in a larger, complex surrounding stimulus (image within image, sound within sound, etc.)
e. User may have multiple personas each with its own target stimulus or stimuli

14. The method of claim 1 whereby the system processes raw EEG data by referencing sensor data to the average of the mastoid sensor data, low pass and high pass filters the data to retain only EEG data within range of P3 ERP signals of interest, separates target and non-target stimulus responses, bounds the responses to −200 msec before and +800 msec after the stimulus, baseline corrects the post stimulus data to the average of the pre-stimulus data, identifies artifacts such as eye blink and rejects those artifacts, and averages separately the target and non-target data for each sensor.

15. The method of claim 1 whereby the system sorts the averaged target and non-target data for each sensor, to identify the peak target sensor which will have collected the highest amplitude P3 ERP target response, and each epoch (all target and non-target responses recorded by the peak sensor) is used to calculate the confidence level whereby:
a. The selected peak sensor is compared to the same sensor for the non-target data.
b. After the epoch file is extracted, a peak detection algorithm detects the peak of each epoch to create the target sensor marker report
c. The non-target marker report is also generated using the same sensor that was identified as the peak target sensor.
d. Once the target and non-target sensor amplitude reports are generated, any values >50 μV or <−50 μV are thrown out since they are outside the range of P3 ERPs
e. The mean and standard deviation of the peak measurements are calculated
f. A normal distribution, such as Student's t distribution, is used, and starting with the highest confidence level (99.99%) the confidence interval (CI) is generated to determine if the target and non-target confidence intervals (CL) overlap.
g. If there is CI overlap, the CL is recursively decremented until the target and non-target confidence intervals do not overlap, at which point authentication is complete and access is allowed
h. If the and non-target CIs continue to overlap when the CL is down to the system defined lowest permissible CL (e.g. 80%), authentication failed, access denied

16. The method of claim 2 whereby the system measures eye blink using one or more sensors embedded in the cap, located on the scalp near the center of the forehead as an alternative to typical EEG eye blink sensors that are more intrusively placed around the subject's eye.

17. The method according to claim 1 whereby the system dynamically authenticates users after allowing initial access, by intermittently presents either a target or non-target stimuli, and measuring their response throughout the time that the user has access to the system, device, or information

18. The method according to claim 1 whereby the system uses multiple statistical processing methods to rapidly calculate authentication confidence levels including but not limited to:
a. The Primary Peak Sensor Method that identifies the sensor with the peak average target response and uses that single sensor to compare target and non-target responses
b. The Multi-Sensor method that averages data from multiple sensors to improve the SNR
c. The Peak Detection Interval Reduction which is similar to method (a), but narrows the peak detection interval (+/−25 msec) to eliminate non-cognitive ERPs and non-relevant artifacts in the non-target responses. This method narrows the peak detection window with little impact on the average target amplitude, but substantial decreases in average non-target amplitude. This method is used to improve separation of target and non-target confidence intervals. This method provides better results for smaller number of trials and faster authentication.

19. The method of claim 15 whereby the statistical comparison is an authentication confidence level that shows the degree to which the user cognitively recognizes his or her chosen target that is continually calculated and revised in real time, and for authorized users, improves as more stimuli are presented, and either deteriorates or remains constant for an illegitimate user trying to illegally gain access.
